(19) United States
(12) Patent Application Publication
(10) Pub. No.: US 2014/0074576 A1
(43) Pub. Date: Mar. 13, 2014

(54) PUBLIC ONLINE ENVIRONMENT FOR DEVELOPING DATA-RICH APPLICATIONS

(71) Applicants: Roger S. Mall, Sammamish, WA (US); Christian Liensberger, Bellevue, WA (US); Adam D. Wilson, Seattle, WA (US); Piotr Milosz Puszkiewicz, Seattle, WA (US)

(72) Inventors: Roger S. Mall, Sammamish, WA (US); Christian Liensberger, Bellevue, WA (US); Adam D. Wilson, Seattle, WA (US); Piotr Milosz Puszkiewicz, Seattle, WA (US)

(73) Assignee: MICROSOFT CORPORATION, Redmond, WA (US)

(21) Appl. No.: 13/609,839

(22) Filed: Sep. 11, 2012

(51) Int. Cl. G06Q 30/02; G06Q 30/06

(52) U.S. Cl. 705/14.23; 705/14.39; 705/14.25

(57) ABSTRACT

Techniques are described herein that are capable of facilitating development of data-rich applications. A data-rich application is an application (e.g., a software application) that is configured to perform an analysis of data (e.g., structured data, unstructured data, or a combination thereof) and to provide information based on the analysis. In accordance with the aforementioned techniques, a public online environment may be provided in which application developers are allowed to access representative samples of data owned by data owners at a substantially reduced cost (e.g., free) to facilitate development of the data-rich applications.

### BACKGROUND

Data owners are under pressure from customers who purchase their data to provide the data in applications so that the data is easier to consume. Data owners often prefer selling small chunks of their data, which may be implemented in views, reports, etc., than giving customers access to all the data. Data owners typically are not application developers, and they tend to focus their efforts on ensuring that the data they offer is robust. Accordingly, building high quality end user data consumption experiences is usually outside the core competencies of the data owners. Consequently, data owners frequently hire third-party application developers to build data-rich applications on their behalf for providing such data consumption experiences, which allow the end users to extract useful information from the data. However, conventional third-party application development models often present a variety of issues for the data owners and the third-party application developers.

For example, data owners typically do not want to assume the risk of exposing all their data to third parties unless the data owners have significant recourse for data leakage. Moreover, data owners usually want visibility into how customers are using their data. Furthermore, many data owners are not capable of providing or do not want to provide application programming interfaces (APIs) and sample code for facilitating the application development efforts of the application developers.

Application developers typically pay data owners in order to use the data of the data owners to develop applications that use the data. Many application developers who build data-rich applications feel that they are helping the data owners sell their data. These application developers therefore believe that they should not be required to buy the data to help the data owners sell the data. Moreover, if an application developer is not large enough for the data owner to engage, the application developer may have difficulty licensing the data. Furthermore, application developers usually do not want the burden of making the data that their applications consume available for their applications. Rather, the application developers usually prefer to call existing APIs in order to access the data.

### SUMMARY

Various approaches are described herein for, among other things, facilitating development of data-rich applications. A data-rich application is an application (e.g., a software application) that is configured to perform an analysis of data (e.g., structured data, unstructured data, or a combination thereof) and to provide information based on the analysis. A public online environment may be provided in which application developers are allowed to access representative samples of data owned by data owners at a substantially reduced cost (e.g., free) to facilitate development of the data-rich applications.

An example method is described in which a public online environment is provided that is configured to facilitate development of data-rich applications. Representative data set(s) are provided in the public online environment that represent respective corpus(es) of data. Each representative data set includes a portion of the respective corpus of structure data. Access to the representative data set(s) is provided to application developers for development of applications, which are configured to provide information based on at least one of the corpus(es) of data, at a substantially discounted cost as compared to a cost to access the corpus(es) of data.

A system is described that includes environment logic, data logic, and access logic. The environment logic is configured to provide a public online environment that is configured to facilitate development of data-rich applications. The data logic is configured to provide representative data set(s) in the public online environment that represent respective corpus(es) of data. Each representative data set includes a portion of the respective corpus of structure data. The access logic is configured to provide access to the representative data set(s) to application developers for development of applications, which are configured to provide information based on at least one of the corpus(es) of data, at a substantially discounted cost as compared to a cost to access the corpus(es) of data.

A computer program product is described that includes a computer-readable medium having computer program logic recorded thereon for enabling a processor-based system to facilitate development of data-rich applications. The computer program product includes a first program logic module, a second program logic module, and a third program logic module. The first program logic module is for enabling the processor-based system to provide a public online environment that is configured to facilitate development of data-rich applications. The second program logic module is for enabling the processor-based system to provide representative data set(s) in the public online environment that represent respective corpus(es) of data. Each representative data set includes a portion of the respective corpus of structure data. The third program logic module is for enabling the processor-based system to provide access to the representative data set(s) to application developers for development of applications, which are configured to provide information based on at least one of the corpus(es) of data, at a substantially discounted cost as compared to a cost to access the corpus(es) of data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example data marketplace system in accordance with an embodiment.

FIGS. 2 and 3 depict flowcharts of example methods for facilitating development of data-rich applications according to embodiments.

FIG. 4 is a block diagram of an example implementation of public online environment logic shown in FIG. 1 in accordance with an embodiment.

FIG. 5 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. Example Embodiments

Example embodiments described herein are capable of facilitating development of data-rich applications. A data-rich application is an application (e.g., a software application) that is configured to perform an analysis of data (e.g., structured data, unstructured data, or a combination thereof) and to provide information based on the analysis. A public online environment may be provided in which application developers are allowed to access representative samples of data owned by data owners at a substantially reduced cost (e.g., free) to facilitate development of the data-rich applications.

Example techniques described herein have a variety of benefits as compared to conventional application development techniques. For instance, the example techniques may bring data owners and application developers together in an open, yet controlled, environment where data owners' interests and concerns are met, while application developers are still able to build data consumption experiences on top of the data. Accordingly, the example techniques may provide a safe environment in which the data owners and the application developers can work together. The example techniques may provide a closed feedback loop between the application developers and the data owners.

The example techniques may reduce (e.g., eliminate) the risk of data owners exposing all their data to third parties. For example, each data owner may provide a representative data set, rather than its entire corpus of data, to the public online environment. In another example, a distinction may be made between application developers and end users. In accordance with this example, a representative data set may be provided to application developers in lieu of a data owner's entire corpus of data, and the entire corpus may be provided to end users who pay for use of the corpus. If an end user has not paid for use of the corpus, an offer to access the corpus in exchange for a fee may be provided to the end user. The example techniques may provide visibility into how customers (e.g., application developers and/or end users) use data of the data owners. APIs and/or sample code may be provided by the public online environment for use by the application developers in developing the data-rich applications.

The example techniques may enable application developers to access the representative data sets of the data owners for no charge or for a nominal fee. Access to the representative data sets may be provided to the application developers without a restriction on use of the representative data sets. Application developers need not necessarily obtain a license to access the representative data sets of the data owners. The example techniques may provide equal access to the representative data sets among the application developers regardless of each application developer's size.

The example techniques may configure a data-rich application to automatically provide access to corpus(es) of data to end users of the application in response to the application being offered for sale in the public online environment. Example embodiments may provide access to corpus(es) of data to an end user via a data-rich application in response to a determination that the end user has purchased access rights with regard to the corpus(es) of data externally from the application.

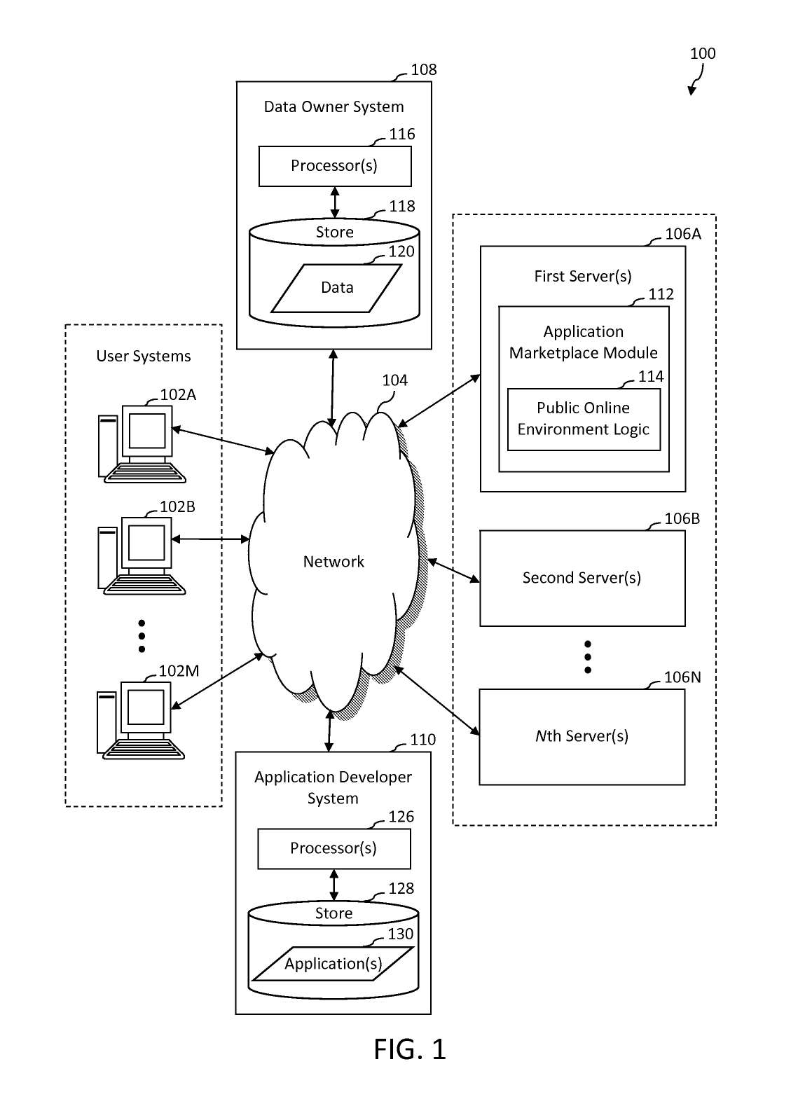

FIG. 1 is a block diagram of an example data marketplace system 100 in accordance with an embodiment. Generally speaking, data marketplace system 100 operates to provide a marketplace in which data owners may sell their data to end users in response to requests (e.g., hypertext transfer protocol (HTTP) requests) that are received from the end users. For example, the end users may request such data via data-rich applications that execute on user systems 102A-102M, which are discussed in further detail below.

In accordance with example embodiments described herein, data marketplace system 100 facilitates development of data-rich applications. For instance, if an application developer develops a data-rich application using data marketplace system 100, data marketplace system 100 may provide a public online environment in which the application developer is allowed to access representative samples of data owned by data owners at a substantially reduced cost (e.g., free) to facilitate development of the data-rich application. The representative samples may include a least amount of data that enables the application developer to obtain meaningful results while testing the data-rich application during its development, though the scope of the example embodiments is not limited in this respect. For instance, limiting the size of the representative samples may help to protect the data owners from disclosure of a substantial amount (e.g., all) of their data at the substantially reduced cost. Detail regarding techniques for facilitating development of data-rich applications is provided in the following discussion.

As shown in FIG. 1, data marketplace system 100 includes a plurality of user systems 102A-102M, a network 104, a plurality of servers 106A-106N, a data owner system 108, and an application developer system 110. Communication among user systems 102A-102M, servers 106A-106N, data owner system 108, and application developer system 110 is carried out over network 104 using well-known network communication protocols. Network 104 may be a wide-area network (e.g., the Internet), a local area network (LAN), another type of network, or a combination thereof.

User systems 102A-102M are processing systems that are capable of communicating with servers 106A-106N. An example of a processing system is a system that includes at least one processor that is capable of manipulating data in accordance with a set of instructions. For instance, a processing system may be a computer, a personal digital assistant, etc. User systems 102A-102M are configured to provide requests to servers 106A-106N for requesting information stored on (or otherwise accessible via) servers 106A-106N.

For instance, a user may initiate a request for such information using a client (e.g., a Web browser, Web crawler, or other type of client) deployed on a user system 102 that is owned by or otherwise accessible to the user. In accordance with some example embodiments, user systems 102A-102M are capable of accessing domains (e.g., Web sites) hosted by servers 104A-104N, so that user systems 102A-102M may access information that is available via the domains. Such domain may include Web pages, which may be provided as hypertext markup language (HTML) documents and objects (e.g., files) that are linked therein, for example. An end user may initiate a request for data via a data-rich application that executes on a user system 102 in accordance with example embodiments.

It will be recognized that any one or more user systems 102A-102M may communicate with any one or more servers 106A-106N. Although user systems 102A-102M are depicted as desktop computers in FIG. 1, persons skilled in the relevant art(s) will appreciate that user systems 102A-102M may include any client-enabled system or device, including but not limited to a desktop computer, a laptop computer, a tablet computer, a personal digital assistant, a cellular telephone, or the like.

Servers 106A-106N are processing systems that are capable of communicating with user systems 102A-102M. Servers 106A-106N are configured to execute computer programs that provide information to end users in response to receiving requests from the end users. For example, the information may include documents (e.g., Web pages, images, video files, etc.), output of executables, raw data, or any other suitable type of information. In accordance with some example embodiments, servers 106A-106N are configured to host respective Web sites, so that the Web sites are accessible to end users of data marketplace system 100.

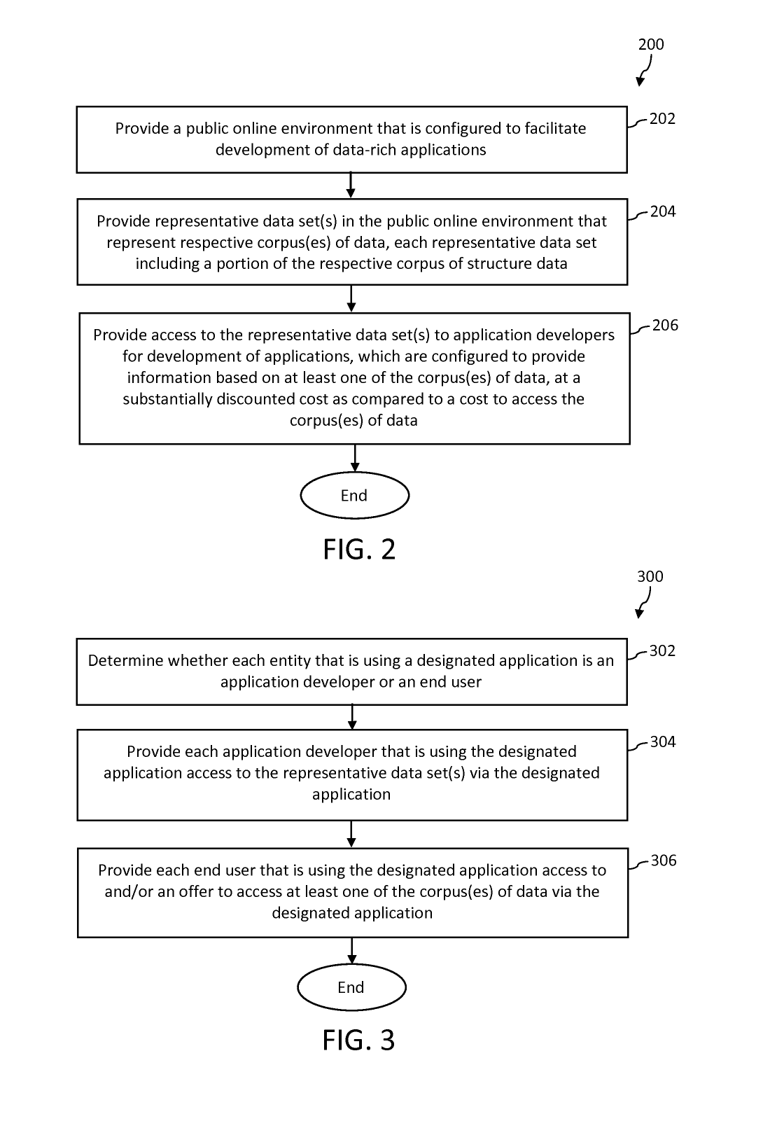

First server 106A is shown to include an application marketplace module 112 for illustrative purposes. Application marketplace module 112 is configured to provide a marketplace in which data owners may purchase data of data owners and/or data-rich applications that use such data. Application marketplace module 112 includes public online environment logic 114. Public online environment logic 114 is configured to facilitate development of data-rich applications. For instance, public online environment logic 114 is capable of providing a public online environment that is configured to facilitate development of data-rich applications. Public online environment logic 114 provides representative data set(s) in the public online environment that represent respective corpus(es) of data. Each representative data set includes a portion of the respective corpus of structure data. Public online environment logic 114 allows application developers to access the representative data set(s) for development of data-rich applications at a substantially discounted cost as compared to a cost to access the corpus(es) of data. Example techniques for facilitating development of data-rich applications are discussed in greater detail below with reference to FIGS. 2-4.

Data owner system 108 is a processing system that is capable of providing data 120 for use by application marketplace module 112. For instance, the data 120 may include a corpus of data and/or a representative data set that includes a portion (i.e., less than all) of the corpus. Data owner system 108 includes processor(s) 116 and store 118. Processor(s) 116 are capable of retrieving the data 120 from store 118 and providing the data 120 to application marketplace module 112 via network 104. Store 118 is configured to store the data 120. Store 120 may be any suitable type of store. One type of store is a database. For instance, store 120 may be a relational database, an entity-relationship database, an object database, an object relational database, an extensible markup language (XML) database, etc. One data owner system 108 is shown in FIG. 1 for purposes of illustration and is not intended to be limiting. It will be recognized that marketplace system 100 may include any suitable number (e.g., 1, 2, 3, etc.) of data owner systems, each storing respective data.

Application developer system 110 is a processing system that is capable of accessing the public online environment that is provided by public online environment logic 114. For instance, application developer system 110 may access representative data set(s) that represent respective corpus(es) of data via the public online environment to develop one or more data-rich applications 130. Application developer system 110 includes processor(s) 126 and store 128. Processor(s) 126 are capable of developing the data-rich application(s) 130 using the representative data set(s) that are accessed via the public online environment. Store 128 is configured to store the data-rich application(s) 130. Store 130 may be any suitable type of store, including but not limited to a database (e.g., a relational database, an entity-relationship database, an object database, an object relational database, an XML database, etc.). One application developer system 110 is shown in FIG. 1 for purposes of illustration and is not intended to be limiting. It will be recognized that marketplace system 100 may include any suitable number (e.g., 1, 2, 3, etc.) of application developer systems, each capable of accessing the public online environment.

Application marketplace module 112 and/or public online environment logic 114 may be implemented in various ways to facilitate development of data-rich applications, including being implemented in hardware, software, firmware, or any combination thereof. For example, application marketplace module 112 and/or public online environment logic 114 may be implemented as computer program code configured to be executed in one or more processors. In another example, application marketplace module 112 and/or public online environment logic 114 may be implemented as hardware logic/electrical circuitry. In an embodiment, application marketplace module 112 and/or public online environment logic 114 may be implemented in a system-on-chip (SoC). Each SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

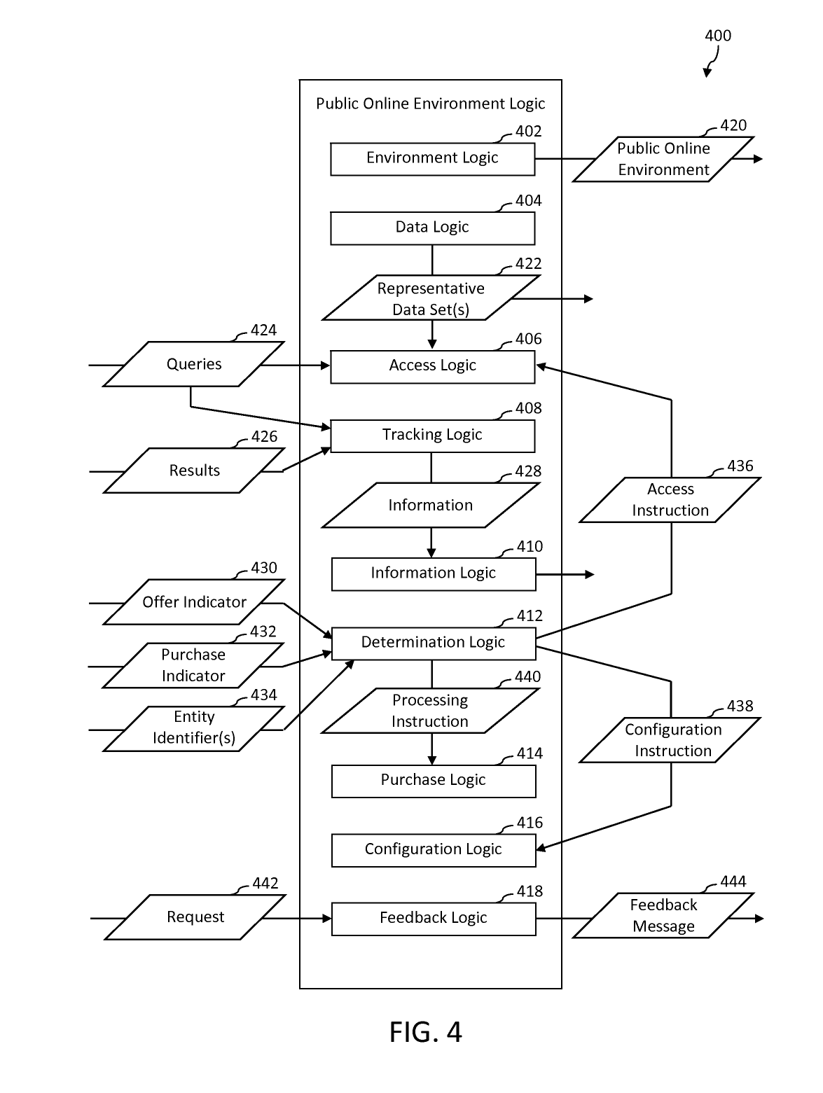

FIGS. 2 and 3 depict flowcharts 200 and 300 of example methods for facilitating development of data-rich applications according to embodiments. Flowcharts 200 and 300 may be performed by public online environment logic 114 of marketplace system 100 shown in FIG. 1, for example. For illustrative purposes, flowcharts 200 and 300 are described with respect to public online environment logic 400 shown in FIG. 4, which is an example of public online environment logic 114, according to an embodiment. As shown in FIG. 4, public online environment logic 400 includes environment logic 402, data logic 404, access logic 406, tracking logic 408, information logic 410, determination logic 412, purchase logic 414, configuration logic 416, and feedback logic 418. Further structural and operational embodiments will be apparent to persons skilled in the relevant art(s) based on the discussion regarding flowcharts 200 and 300.

As shown in FIG. 2, the method of flowchart 200 begins at step 202. In step 202, a public online environment that is configured to facilitate development of data-rich applications is provided. For instance, the public online environment may be accessible via a user interface (e.g., a Web-based user interface). In an example implementation, environment logic 402 provides public online environment 420.

At step 204, representative data set(s) are provided in the public online environment. The representative data set(s) represent respective corpus(es) of data. Each representative data set includes a portion (i.e., less than all) of the respective corpus of structure data. For example, a representative data set may include approximately (or less than) one-fourth of the respective corpus, less approximately (or less than) one-tenth of the respective corpus, approximately (or less than) 5% of the respective corpus, etc. In another example, a representative data set may include fewer than all data rows and/or fewer than all parameters in each data row of the respective corpus. Each corpus of data may be associated with a respective topic and/or a respective data owner, though the example embodiments are not limited in this respect. Accordingly, each of the representative data set(s) may include any suitable type of data, including but not limited to demographic data, weather data, barcode data (e.g., information regarding skews), national death index data, etc. For example, such various types of data may be provided in the public online environment without limitation. In accordance with this example, no restrictions may exist with regard to the types of data that may be provided in the public online environment. In an example implementation, data logic 404 provides representative data set(s) 422 in the public online environment 420.

At step 206, access to the representative data set(s) is provided to application developers for development of applications, which are configured to provide information based on at least one of the corpus(es) of data, at a substantially discounted cost as compared to a cost to access the corpus(es) of data. For example, the cost to access the representative data set(s) may be substantially discounted as compared to a cost to access any one or more of the corpus(es) (e.g., a single one of the corpus(es)). In another example, the substantially discounted cost may be a nominal fee or free. Examples of a nominal fee include but are not limited to a fee that is less than or equal to $1, a fee that is less than or equal to $10, a fee that is discounted at least 90%, 95%, 99%, 99.5%, etc. with regard to the cost to access the corpus(es) of data. The substantially discounted cost may substantially reduce (e.g., eliminate) a barrier to entry for the application developers to gain access to the representative data set(s). Access to the representative data set(s) may be provided to the application developers without limitation on use of the representative data set(s), though the scope of the example embodiments is not limited in this respect. For instance, the application developers may be allowed to use the representative data set(s) with no restrictions on which data rows, parameters in each data row, etc. of the representative data set(s) may be used. Providing the access to the representative data set(s) may include providing a user interface or an interface element within a user interface that enables the application developers to access the representative data set(s), though the scope of the example embodiments is not limited in this respect. In an example implementation, access logic 406 provides access to the representative data set(s) 422 to the application developers for development of the applications.

In some example embodiments, one or more steps 202, 204, and/or 206 of flowchart 200 may not be performed. Moreover, steps in addition to or in lieu of steps 202, 204, and/or 206 may be performed.

For instance, in an example embodiment, the method of flowchart 200 further includes tracking queries that are received from the application developers with regard to the representative data set(s). For instance, tracking logic 408 may track queries 424 received from the application developers with regard to the representative data set(s) 422. In accordance with this embodiment, the method of flowchart 200 further includes providing query information regarding the queries to owner(s) of the representative data set(s). For instance, providing the query information may enable the owner(s) to refine the representative data set(s) and/or corresponding corpus(es) of data to include data that corresponds to the queries. For example, tracking logic 408 may generate information 428 regarding the queries 424. In accordance with this example, information logic 410 may provide the information 428 to the owner(s) of the representative data set(s) 422.

In another example embodiment, the method of flowchart 200 further includes tracking resultless queries received from the application developers. Resultless queries are queries for which no results are returned with regard to at least one of the representative data set(s). For example, the resultless queries may be included in the queries 424. In accordance with this example, tracking logic 408 may track the resultless queries. In further accordance with this example, tracking logic 408 may generate the information 428 to specify the resultless queries.

In accordance with this embodiment, the method of flowchart 200 further includes providing query information to owner(s) of the at least one of the representative data set(s) indicating that no results are returned in response to the resultless queries with regard to the at least one of the representative data set(s). For instance, information logic 410 may provide the information 428 to the owner(s) of the at least one of the representative data set(s) 422.

In yet another example embodiment, the method of flowchart 200 further includes tracking whether a result is returned with regard to each of the representative data set(s) in response to at least one query that is received from at least one of the application developers to provide set information. A result is returned with regard to a representative data set in response to a query when data is retrieved from the representative data set based on the query. For example, tracking logic 408 may track results 426, which are received in response to the queries 424. In accordance with this example, tracking logic 408 may track whether results 426 includes a result for each of the representative data set(s) 422 for any one or more of the queries 424. In a first aspect of this example, tracking logic 408 may generate information 428 to indicate one or more of the representative data set(s) 422 for which a result is not received. In a second aspect of this example, tracking logic 408 may generate information 428 to indicate one or more of the representative data set(s) 422 for which a result is received.

In accordance with this embodiment, the method of flowchart 200 further includes providing the set information to owner(s) of the representative data set(s). In accordance with the first aspect of the example above, information logic 410 may provide the information 428 to the one or more data owners that own the one or more representative data set(s) for which a result is not received. In accordance with the first aspect, a first owner may be provided first information indicating that a result is not received for a first representative data set; a second owner may be provided second information indicating that a result is not received for a second representative data set, and so on.

In accordance with the second aspect of the example above, information logic 410 may provide the information 428 to the one or more data owners that own the one or more representative data set(s) for which a result is received. In accordance with the second aspect, a first owner may be provided first information indicating that a result is received for a first representative data set; a second owner may be provided second information indicating that a result is received for a second representative data set, and so on.

In still another example embodiment, the method of flowchart 200 further includes tracking whether a result is returned with regard to each of a plurality of parameters in at least one of the representative data set(s) in response to at least one query that is received from at least one of the application developers to provide parameter information. A result is returned with regard to a parameter in a representative data set in response to a query when data corresponding to the parameter in the representative data set is retrieved based on the query. For example, each of the results 426 may be associated with a parameter in a representative data set. In accordance with this example, tracking logic 408 may track whether results 426 includes a result for each of the plurality of parameters in each of the representative data set(s) 422 for any one or more of the queries 424. In a first aspect of this example, tracking logic 408 may generate information 428 to indicate one or more of the parameters in the representative data set(s) 422 for which a result is not received. In a second aspect of this example, tracking logic 408 may generate information 428 to indicate one or more of the parameters in the representative data set(s) 422 for which a result is received.

In accordance with this embodiment, the method of flowchart 200 further includes providing the parameter information to owner(s) of the at least one of the representative data set(s). For instance, providing the parameter information may prompt the owner(s) to remove parameter(s) that are not utilized with regard to queries that are received from the application developers and/or to add parameter(s) that correspond to the queries and that are not already included in the at least one of the representative data set(s).

In accordance with the first aspect of the example above, information logic 410 may provide the information 428 to the one or more data owners that own the one or more representative data set(s) that include the one or more parameters for which a result is not received. In accordance with the first aspect, a first owner may be provided first information indicating that a result is not received for one or more parameters in a first representative data set; a second owner may be provided second information indicating that a result is not received for one or more parameters in a second representative data set, and so on.

In accordance with the second aspect of the example above, information logic 410 may provide the information 428 to the one or more data owners that own the one or more representative data set(s) that include the one or more parameters for which a result is received. In accordance with second aspect, a first owner may be provided first information indicating that a result is received for one or more parameters in a first representative data set; a second owner may be provided second information indicating that a result is received for one or more parameters in a second representative data set, and so on.

In another example embodiment, the method of flowchart 200 further includes receiving a request from a developer (e.g., an application developer) to revise a designated representative data set of the representative data set(s) to include specified parameter(s). For instance, feedback logic 418 may receive request 442, which requests that the designated representative data set be revised to include the specified parameter(s). In accordance with this embodiment, the method of flowchart 200 further includes providing a feedback message to an owner of the designated representative data set to indicate that revision of the designated representative data set to include the specified parameter(s) is requested. A feedback message is a message that is provided to a data owner regarding a request from a developer about a representative data set that is owned by the data owner. For example, feedback logic 418 may provide feedback message 444 to the owner of the designated representative data set. In accordance with this example, the feedback message 444 may indicate that revision of the designated representative data set to include the specified parameter(s) is requested.

In yet another example embodiment, the method of flowchart 200 further includes processing purchases of applications via the public online environment externally from the applications. For example, a sample of code may be included in each application for calling public online environment logic 400 to process each purchase of the respective application. In accordance with this example, a configuration file may be modified to indicate that specified corpus(es) of data are to be accessed with regard to the application. For instance, determination logic 412 may read the configuration file to determine that the specified corpus(es) are to be accessed with regard to the application.

In an aspect of this embodiment, the method of flowchart 200 further includes processing a purchase of a designated application that is initiated by an end user via the public online environment in response to a call from the designated application to the public online environment. For example, determination logic 412 may determine that the designated application is purchased based on receipt of a purchase indicator 432. In accordance with this example, the purchase indicator 432 may specify that the designated application is purchased. The purchase indicator 432 may specify an end user who purchases the designated application, a cost of the designated application, applicable discount(s) with regard to the designated application, a form of payment (e.g., debit card, credit card, etc.), and/or other information to facilitate processing of the purchase. In further accordance with this example, determination logic 412 may provide a processing instruction 440 to purchase logic 414 in response to receiving the purchase indicator 432. The processing instruction 440 may specify that the purchase of the designated application is to be processed by purchase logic 414. The processing instruction 440 may include other information that is specified by the purchase indicator 432. In further accordance with this example, purchase logic 414 processes the purchase of the designated application based on the processing instruction 440. In an aspect of this example, the purchase indicator 432 may include the call from the designated application.

In still another example embodiment, the method of flowchart 200 further includes automatically configuring a designated application to provide access to at least one of the corpus(es) of data to end users of the designated application in response to the designated application being offered for sale in the public online environment. For example, determination logic 412 may automatically determine that the designated application is offered for sale in the public online environment 420 based on receipt of an offer indicator 430. In accordance with this example, the offer indicator 430 may specify that the designated application is offered for sale in the public online environment 420. In further accordance with this example, determination logic 412 may automatically provide a configuration instruction 438 to configuration logic 416 in response to receiving the offer indicator 430. The configuration instruction 438 may specify that the designated application is to be configured to provide access to the at least one of the corpus(es) of data to end users of the designated application. In further accordance with this example, configuration logic 416 automatically configures the designated application to provide access to the at least one of the corpus(es) of data to end users of the designated application based on the configuration instruction 438.

In another example embodiment, the method of flowchart 200 further includes determining that an end user purchases access rights with regard to a designated corpus of data externally from a specified application. For example, determination logic 412 may determine that the end user purchases access rights with regard to the designated corpus externally from the specified application based on receipt of the purchase indicator 432. In accordance with this example, the purchase indicator 432 may specify that the end user has purchased access rights with regard to the designated corpus externally from the specified application.

In accordance with this embodiment, the method of flowchart 200 further includes automatically providing access to the designated corpus of data to the end user via the specified application in response to determining that the end user purchases the access rights. For example, determination logic 412 may automatically provide an access instruction 436 to access logic 406 in response to receiving the purchase indicator 432. The access instruction 436 may specify that the end user is to be provided access to the designated corpus of data via the specified application. In further accordance with this example, access logic 406 automatically provides access to the designated corpus of the data to the end user via the specified application based on the access instruction 436.

In yet another example embodiment, the method of flowchart 200 further includes determining that an end user purchases a designated application externally from a marketplace that includes the public online environment. For example, determination logic 412 may determine that the end user purchases the designated application externally from the marketplace that includes the public online environment 420 based on receipt of the purchase indicator 432. In accordance with this example, the purchase indicator 432 may specify that the end user has purchased the designated application externally from the marketplace that includes the public online environment 420.

In accordance with this embodiment, the method of flowchart 200 further includes automatically associating at least one of the corpus(es) of data with the designated application in response to the end user bringing the designated application into the marketplace that includes the public online environment. For example, determination logic 412 may automatically provide the access instruction 436 to access logic 406 in response to receiving the purchase indicator 432. The access instruction 436 may specify that the at least one of the corpus(es) of data is to be automatically associated with the designated application. In further accordance with this example, access logic 406 automatically associates the at least one of the corpus(es) of data with the designated application based on the access instruction 436.

In still another example embodiment, the method of flowchart 200 further includes one or more of the steps shown in flowchart 300 of FIG. 3. As shown in FIG. 3, the method of flowchart 300 begins at step 302. In step 302, a determination is made whether each entity that is using a designated application is an application developer or an end user. In an example implementation, determination logic 412 determines whether each entity that is using the designated application is an application developer or an end user based on entity identifier(s) 434. For example, determination logic 412 may receive an entity identifier for each entity, though the scope of the example embodiments is not limited in this respect. In accordance with this example, each of the entity identifier(s) 434 specifies either that the respective entity is an application developer or that the respective entity is an end user. In further accordance with this example, determination logic 412 provides an access instruction 436 to access logic 406 for each of the entities that is specified by an entity identifier. Determination logic 412 configures each access instruction 436 to indicate that the respective entity is to be provided access to the representative data set(s) via the designated application if the respective entity identifier specifies that the respective entity is an application developer. Determination logic 412 configures each access instruction 436 to indicate that the respective entity is to be provided access to and/or an offer to access at least one of the corpus(es) of data via the designated application if the respective entity identifier specifies that the respective entity is an end user.

At step 304, each application developer that is using the designated application is provided access to the representative data set(s) via the designated application. In an example implementation, access logic 406 provides each application developer that is using the designated application access to the representative data set(s) via the designated application based on the access instruction 436 for the respective application developer.

At step 306, each end user that is using the designated application is provided access to and/or an offer to access at least one of the corpus(es) of data via the designated application. For instance, providing an offer to access at least one of the corpus(es) of data may include providing a user interface or an interface element in a user interface that enables an end user to purchase and/or obtain a license to the at least one of the corpus(es) of data. In an example implementation, access logic 406 provides each end user that is using the designated application access to and/or an offer to access at least one of the corpus(es) of data via the designated application based on the access instruction 436 for the respective end user.

It will be recognized that public online environment logic 400 may not include one or more of environment logic 402, data logic 404, access logic 406, tracking logic 408, information logic 410, determination logic 412, purchase logic 414, configuration logic 416, and/or feedback logic 418. Furthermore, public online environment logic 400 may include modules in addition to or in lieu of environment logic 402, data logic 404, access logic 406, tracking logic 408, information logic 410, determination logic 412, purchase logic 414, configuration logic 416, and/or feedback logic 418.

Application marketplace module 112, public online environment logic 114, environment logic 402, data logic 404, access logic 406, tracking logic 408, information logic 410, determination logic 412, purchase logic 414, configuration logic 416, feedback logic 418, flowchart 200, and flowchart 300 may be implemented in hardware, software, firmware, or any combination thereof.

For example, application marketplace module 112, public online environment logic 114, environment logic 402, data logic 404, access logic 406, tracking logic 408, information logic 410, determination logic 412, purchase logic 414, configuration logic 416, feedback logic 418, flowchart 200, and/or flowchart 300 may be implemented as computer program code configured to be executed in one or more processors.

In another example, application marketplace module 112, public online environment logic 114, environment logic 402, data logic 404, access logic 406, tracking logic 408, information logic 410, determination logic 412, purchase logic 414, configuration logic 416, feedback logic 418, flowchart 200, and/or flowchart 300 may be implemented as hardware logic/electrical circuitry.

For instance, in an embodiment, one or more of application marketplace module 112, public online environment logic 114, environment logic 402, data logic 404, access logic 406, tracking logic 408, information logic 410, determination logic 412, purchase logic 414, configuration logic 416, feedback logic 418, flowchart 200, and/or flowchart 300 may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

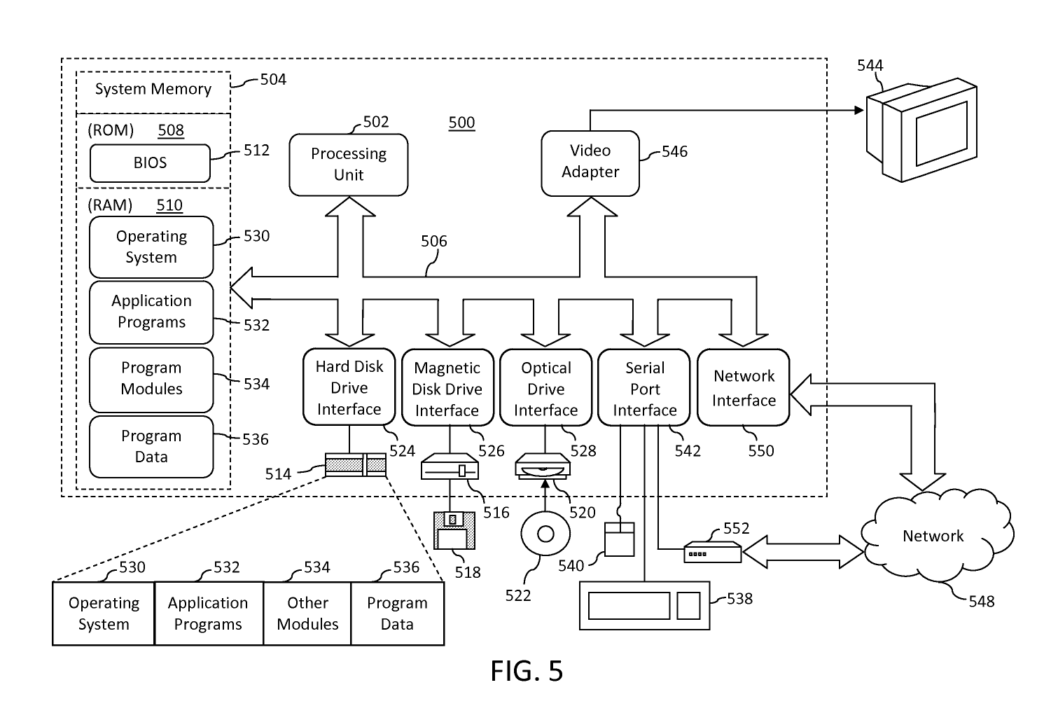

FIG. 5 depicts an example computer 500 in which embodiments may be implemented. Any one or more of the clients 102A-102M, data owner system 108, application developer system 110, or any one or more of servers 106A-106N shown in FIG. 1 (or any one or more subcomponents thereof shown in FIG. 4) may be implemented using computer 500, including one or more features of computer 500 and/or alternative features. Computer 500 may be a general-purpose computing device in the form of a conventional personal computer, a mobile computer, or a workstation, for example, or computer 500 may be a special purpose computing device. The description of computer 500 provided herein is provided for purposes of illustration, and is not intended to be limiting. Embodiments may be implemented in further types of computer systems, as would be known to persons skilled in the relevant art(s).

As shown in FIG. 5, computer 500 includes a processing unit 502, a system memory 504, and a bus 506 that couples various system components including system memory 504 to processing unit 502. Bus 506 represents one or more of any of several types of bus structures, including a memory bus or memory controller, a peripheral bus, an accelerated graphics port, and a processor or local bus using any of a variety of bus architectures. System memory 504 includes read only memory (ROM) 508 and random access memory (RAM) 510. A basic input/output system 512 (BIOS) is stored in ROM 508.

Computer 500 also has one or more of the following drives: a hard disk drive 514 for reading from and writing to a hard disk, a magnetic disk drive 516 for reading from or writing to a removable magnetic disk 518, and an optical disk drive 520 for reading from or writing to a removable optical disk 522 such as a CD ROM, DVD ROM, or other optical media. Hard disk drive 514, magnetic disk drive 516, and optical disk drive 520 are connected to bus 506 by a hard disk drive interface 524, a magnetic disk drive interface 526, and an optical drive interface 528, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 530, one or more application programs 532, other program modules 534, and program data 536. Application programs 532 or program modules 534 may include, for example, computer program logic for implementing marketplace module 112, public online environment logic 114, environment logic 402, data logic 404, access logic 406, tracking logic 408, information logic 410, determination logic 412, purchase logic 414, configuration logic 416, feedback logic 418, flowchart 200 (including any step of flowchart 200), and/or flowchart 300 (including any step of flowchart 300), as described herein.

A user may enter commands and information into the computer 500 through input devices such as keyboard 538 and pointing device 540. Other input devices (not shown) may include a microphone, joystick, game pad, satellite dish, scanner, touch screen, camera, accelerometer, gyroscope, or the like. These and other input devices are often connected to the processing unit 502 through a serial port interface 542 that is coupled to bus 506, but may be connected by other interfaces, such as a parallel port, game port, or a universal serial bus (USB).

A display device 544 (e.g., a monitor) is also connected to bus 506 via an interface, such as a video adapter 546. In addition to display device 544, computer 500 may include other peripheral output devices (not shown) such as speakers and printers.

Computer 500 is connected to a network 548 (e.g., the Internet) through a network interface or adapter 550, a modem 552, or other means for establishing communications over the network. Modem 552, which may be internal or external, is connected to bus 506 via serial port interface 542.

As used herein, the terms “computer program medium” and “computer-readable medium” are used to generally refer to non-transitory media such as the hard disk associated with hard disk drive 514, removable magnetic disk 518, removable optical disk 522, as well as other non-transitory media such as flash memory cards, digital video disks, random access memories (RAMs), read only memories (ROM), and the like. Such computer-readable storage media are distinguished from and non-overlapping with communication media. Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Example embodiments are also directed to such communication media.

As noted above, computer programs and modules (including application programs 532 and other program modules 534) may be stored on the hard disk, magnetic disk, optical disk, ROM, or RAM. Such computer programs may also be received via network interface 550 or serial port interface 542. Such computer programs, when executed or loaded by an application, enable computer 500 to implement features of embodiments discussed herein. Accordingly, such computer programs represent controllers of the computer 500.

Example embodiments are also directed to computer program products comprising software (e.g., computer-readable instructions) stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

### III. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described example embodiments, but should be defined only in accordance with the following claims and their equivalents.

What is claimed is:

1. A method comprising:
providing a public online environment that is configured to facilitate development of data-rich applications;
providing one or more representative data sets in the public online environment that represent one or more respective corpuses of data, each representative data set including a portion of the respective corpus of structure data; and
providing access to the one or more representative data sets to application developers for development of applications, which are configured to provide information based on at least one of the one or more corpuses of data, at a substantially discounted cost as compared to a cost to access the one or more corpuses of data.

2. The method of claim 1, wherein providing the access to the one or more representative data sets comprises:
providing the access to the one or more representative data sets to the application developers without restricting use of the one or more representative data sets by the application developers.

3. The method of claim 1, further comprising:
tracking resultless queries received from the application developers for which no results are returned with regard to at least one of the one or more representative data sets; and
providing query information to one or more owners of the at least one of the one or more representative data sets indicating that no results are returned in response to the resultless queries with regard to the at least one of the one or more representative data sets.

4. The method of claim 1, further comprising:
tracking whether a result is returned with regard to each of a plurality of parameters in at least one of the one or more representative data sets in response to at least one query that is received from at least one of the application developers to provide parameter information; and
providing the parameter information to one or more owners of the at least one of the one or more representative data sets.

5. The method of claim 4, wherein the tracking comprises:
determining that a result is not returned with regard to one or more designated parameters in the plurality of parameters in response to the at least one query; and
wherein the parameter information indicates that a result is not returned with regard to the one or more designated parameters in response to the at least one query.

6. The method of claim 1, further comprising:
receiving a request from a developer to revise a designated representative data set of the one or more representative data sets to include one or more specified parameters; and
providing a feedback message to an owner of the designated representative data set to indicate that revision of the designated representative data set to include the one or more specified parameters is requested.

7. The method of claim 1, further comprising:
processing a purchase of a designated application via the public online environment in response to a call from the designated application to the public online environment, the purchase being initiated by an end user.

8. The method of claim 1, further comprising:
automatically configuring a designated application to provide access to at least one of the one or more corpuses of data to end users of the designated application in response to the designated application being offered for sale in the public online environment.

9. The method of claim 1, further comprising:
determining whether each entity that is using a designated application is an application developer or an end user;
providing each application developer that is using the designated application access to the one or more representative data sets via the designated application; and
providing each end user that is using the designated application at least one of access to or an offer to access at least one of the one or more corpuses of data via the designated application.

10. The method of claim 1, further comprising:
determining that an end user purchases a designated application externally from a marketplace that includes the public online environment; and
automatically associating at least one of the one or more corpuses of data with the designated application in response to the end user bringing the designated application into the marketplace that includes the public online environment.

11. A system comprising:
environment logic configured to provide a public online environment, the public online environment being configured to facilitate development of data-rich applications;
data logic configured to provide one or more representative data sets in the public online environment that represent one or more respective corpuses of data, each representative data set including a portion of the respective corpus of structure data; and
access logic configured to provide access to the one or more representative data sets to application developers for development of applications, which are configured to provide information based on at least one of the one or more corpuses of data, at a substantially discounted cost as compared to a cost to access the one or more corpuses of data.

12. The system of claim 11, wherein the access logic is configured to provide the access to the one or more representative data sets to the application developers without restricting use of the one or more representative data sets by the application developers.

13. The system of claim 11, further comprising:
tracking logic configured to track queries that are received from the application developers with regard to the one or more representative data sets; and
information logic configured to provide query information regarding the queries to owners of the one or more representative data sets.

14. The system of claim 11, further comprising:
tracking logic configured to track whether a result is returned with regard to each of the one or more representative data sets in response to at least one query that is received from at least one of the application developers to provide set information; and
information logic configured to provide the set information to one or more owners of the one or more representative data sets.

15. The system of claim 11, further comprising:
tracking logic configured to track whether a result is returned with regard to each of a plurality of parameters in at least one of the one or more representative data sets in response to at least one query that is received from at least one of the application developers to provide parameter information; and
information logic configured to provide the parameter information to one or more owners of the at least one of the one or more representative data sets.

16. The system of claim 11, further comprising:
feedback logic configured to provide a feedback message to an owner of a designated representative data set of the one or more representative data sets to indicate that revision of the designated representative data set to include one or more specified parameters is requested, in response to receipt of a request from a developer to revise the designated representative data set to include the one or more specified parameters.

17. The system of claim 11, further comprising:
configuration logic that automatically configures a designated application to provide access to at least one of the one or more corpuses of data to end users of the designated application in response to the designated application being offered for sale in the public online environment.

18. The system of claim 11, further comprising:
determination logic configured to determine whether an entity that is using a designated application is an application developer or an end user;
wherein the access logic is configured to provide the entity access to the one or more representative data sets via the designated application in response to the entity being an application developer; and
wherein the access logic is configured to provide the entity at least one of access to or an offer to access at least one of the one or more corpuses of data via the designated application in response to the entity being an end user.

19. The system of claim 11, further comprising:
determination logic configured to determine whether an end user purchases access rights with regard to a designated corpus of data externally from a specified application;
wherein the access logic is configured to automatically provide access to the designated corpus of data to the end user via the specified application in response to a determination that the end user purchases the access rights.

20. A computer program product comprising a computer-readable medium having computer program logic recorded thereon for enabling a processor-based system to facilitate development of data-rich applications, the computer program product comprising:
a first program logic module for enabling the processor-based system to provide a public online environment that is configured to facilitate development of data-rich applications;
a second program logic module for enabling the processor-based system to provide one or more representative data sets in the public online environment that represent one or more respective corpuses of data, each representative data set including a portion of the respective corpus of structure data; and
a third program logic module for enabling the processor-based system to provide access to the one or more representative data sets to application developers for development of applications, which are configured to provide information based on at least one of the one or more corpuses of data, at a substantially discounted cost as compared to a cost to access the one or more corpuses of data without restricting use of the one or more representative data sets by the application developers.
